(19) United States
(12) Patent Application Publication
(10) Pub. No.: US 2010/0136437 A1
(43) Pub. Date: Jun. 3, 2010

(54) NONAQUEOUS SECONDARY BATTERY AND METHOD OF PRODUCING THE SAME

(75) Inventors: Takuma Nishida, Saitama (JP); Akihiro Modeki, Saitama (JP); Yoshiki Sakaguchi, Saitama (JP)

Correspondence Address: YOUNG & THOMPSON, 209 Madison Street, Suite 500, Alexandria, VA, 22314, US

(73) Assignee: MITSUI MINING & SMELTING CO., LTD., TOKYO (JP)

(21) Appl. No.: 12/593,563

(22) PCT Filed: Oct. 11, 2007
(86) PCT No.: PCT/JP2007/069812

§ 371 Date: Sep. 28, 2009

(30) Foreign Application Priority Data
Mar. 28, 2007 (JP) 2007-085497

(51) Int. Cl. H01M 6/16; H01M 6/04; H01M 6/00

(52) U.S. Cl. 429/330; 429/188; 29/623.5

(57) ABSTRACT

A nonaqueous secondary battery having a negative electrode containing a silicon active material and a nonaqueous solvent containing a fluorine-containing solvent. The active material layer has a fluorine content of 5 to 30 wt % based on the silicon content after at least 100 charge/discharge cycles at a rate of 50% or more of the battery's capacity. The battery is suitably produced by a method including applying a slurry containing silicon active material particles to a current collector, electroplating the resulting coating layer using a plating bath at a pH higher than 7 to coat at least part of the surface of the particles with copper, acid washing the coating layer to make a negative electrode, assembling the negative electrode together with a positive electrode, a separator, and a nonaqueous electrolyte containing a fluorine-containing solvent into a nonaqueous secondary battery, and subjecting the battery to a first charge operation at a low rate of 0.005 to 0.03 C.

### TECHNICAL FIELD

This invention relates to a nonaqueous secondary battery, such as a lithium secondary battery, and a method of producing the same.

### BACKGROUND ART

It is known that a nonaqueous secondary battery having silicon as a negative electrode active material involves a problem that silicon pulverizes with charge/discharge cycles. It is said that pulverization of silicon leads to destruction of the electroconductive network in the negative electrode active material layer, resulting in deterioration of cycle characteristics. The silicon pulverization is considered to be because the active material layer does not wholly participate in absorption and release of lithium. That is, only the part of silicon near the surface of the active material layer is able to participate in lithium absorption/release so that considerable volumetric change associated with lithium absorption/release occurs locally. To overcome this problem, the inventors of the present invention previously proposed a negative electrode the active material layer of which is able to uniformly absorb and release lithium as a whole (see Patent Document 1). The proposed negative electrode provides a secondary battery with improved cycle characteristics. With this negative electrode, nevertheless, there still is a problem that the electroconductive network can destroy in the last stage of charge/discharge cycling to cause deterioration of cycle characteristics.

In addition to the electroconductive network destruction, deterioration of the active material (silicon) also causes deterioration of nonaqueous secondary battery cycle characteristics. For example, Patent Document 2 mentions that silicon undergoes oxidative alteration and becomes porous with charge/discharge cycles and proposes incorporating into a positive electrode an additive suppressing silicon oxidation.

Patent document 1: JP 2007-27102A

Patent document 2: US 2006/0222944A1

### DISCLOSURE OF THE INVENTION

An object of the invention is to provide a nonaqueous secondary battery with further improved performance over the conventional secondary batteries.

The invention provides a nonaqueous secondary battery comprising a negative electrode which has an active material layer containing silicon as an active material, and nonaqueous solvent containing a fluorine-containing solvent. The active material layer of the negative electrode which is taken out of the battery after at least 100 charge/discharge cycles to 50% or more of the battery's capacity has a fluorine content of 5% to 30% by weight based on a silicon content in the active material layer.

The invention also provides a method of producing a nonaqueous secondary battery comprising the steps of:

making a negative electrode, the step of making a negative electrode comprising the substeps of applying a slurry containing particles of silicon as an active material to a current collector to form a coating layer, electroplating the coating layer using a copper plating bath at a pH higher than 7 to coat at least part of a surface of the particles with copper, and acid washing the plated coating layer,

assembling the negative electrode together with a positive electrode, a separator, and a nonaqueous electrolyte containing a fluorine-containing solvent into a nonaqueous secondary battery, and

subjecting the battery to a first charge operation at a low rate of 0.005 to 0.03 C.

### BRIEF DESCRIPTION OF THE DRAWINGS

FIG. 1 is a cross-section of an illustrative example of the negative electrode used in the nonaqueous secondary battery of the invention.

FIG. 2(a), FIG. 2(b), and FIG. 2(c) each present a backscatter electron image of a cross-section of the negative electrode active material layer of the secondary battery obtained in Example 1.

### BEST MODE FOR CARRYING OUT THE INVENTION

The present invention will be described based on its preferred embodiments. The nonaqueous secondary battery of the invention includes a positive electrode, a negative electrode, and a separator interposed between the electrodes. The space between the positive and the negative electrodes is filled with a nonaqueous electrolyte having a lithium salt as a supporting electrolyte dissolved in a nonaqueous solvent. The secondary battery of the invention may have a coin or button configuration or a jelly-roll configuration. A jelly-roll configuration may have either a circular or a rectangular cross-section.

The positive electrode to be used in the secondary battery is obtained as follows. A positive electrode active material and, if necessary, an electroconductive material and a binder are suspended in an appropriate solvent to prepare a positive electrode active material mixture. The active material mixture is applied to a current collector, dried, rolled, and pressed, followed by cutting or punching. Any known active materials for a positive electrode may be used, including lithium-transition metal complex oxides, such as lithium nickel complex oxide, lithium manganese complex oxide, and lithium cobalt complex oxide.

Exemplary and preferred separators to be used in the battery are nonwoven fabric of synthetic resins and porous film of polyolefins, such as polyethylene and polypropylene, or polytetrafluoroethylene. In order to control heat generation of the electrode due to overcharge of the battery, it is preferred to use, as a separator, a polyolefin microporous film having a ferrocene derivative thin film on one or both sides thereof. It is preferred for the separator to have a puncture strength of 0.2 to 0.49 N/μm-thickness and a tensile strength of 40 to 150 MPa in the winding axial direction so that it may have resistance to damage and thereby prevent occurrence of a short circuit even in using a negative electrode active material that undergoes large expansion and contraction with charge/discharge cycles.

The negative electrode used in the invention is composed of a current collector having on one or both sides thereof an active material layer containing silicon as an active material. The negative electrode active material layer may be a particulate layer containing silicon particles such as, e.g., disclosed in EP 1566855A1 and EP 1617497A1, a sintered layer containing silicon particles such as, e.g., disclosed in US 2004/0043294A1, or a continuous thin layer having a silicon columnar structure such as, e.g., disclosed in JP 2003-17040A. As used herein, the phrase “active material layer containing silicon as an active material” means a layer containing elemental silicon as an active ingredient. It is acceptable for the active material layer to unavoidably contain a small amount (e.g., not more than 3% by weight) of impurities.

The secondary battery of the invention is characterized in that silicon as a negative electrode active material is prevented from deterioration and pulverization even after repetition of charge/discharge cycles. As a result of investigations, the inventors have found that a nonaqueous solvent or a lithium salt (e.g., LiPF₆) decomposes with charge/discharge cycles, and the decomposition product (e.g., LiF) deposits on the surface of silicon or reacts with silicon to form an alteration product (e.g., Li₂SiF₆) and that such a decomposition product or an alteration product is one of the causes of the silicon alteration. The decomposition product and the alteration product increase reaction resistance between silicon and lithium, namely, reduce the reversibility of the reaction (lithium absorbing and releasing properties). Production of the alteration product gradually proceeds from the surface toward the inside of the silicon with charge/discharge cycles. In order to prevent silicon deterioration causes by the alteration, therefore, it is effective, the inventors have found, to form a coat that prevents silicon deterioration on the surface of silicon thereby to inhibit production of the above described decomposition or alteration product and the progress of the production toward the inside of silicon.

The inventors have revealed that a fluorine-containing coat formed by the silicon reacting mainly with a fluorine-containing nonaqueous solvent is effective to protect silicon from deterioration. Although the substance making up the coat has not yet been clearly identified and needs further investigation, the inventors have proved at least that formation of a coat having desired characteristics is achieved when the active material layer has a specific fluorine to silicon atomic ratio after repeated charge/discharge cycles under a prescribed condition.

In determining the fluorine to silicon atomic ratio referred to above, the object of analysis is the active material layer of a negative electrode taken out of a battery having been subjected to 100 charge/discharge cycles to 50% or more of the battery capacity. The negative electrode taken out is thoroughly washed with dimethyl carbonate to be freed of the nonaqueous electrolyte and dried to prepare a specimen, which is analyzed for silicon and fluorine contents by energy dispersive X-ray (EDX) analyzer to calculate a fluorine to silicon ratio. The fluorine to be determined is the one having reacted with the elements present in the active material layer, the most of which is silicon, because fluorine that has not reacted with silicon has been removed by washing with dimethyl carbonate. When the thus determined F to Si ratio ranges from 5% to 30%, preferably 7% to 15%, by weight, this indicates that there is formed a fluorine-containing coat competent to protect silicon from deterioration on the surface of silicon. If the ratio is less than 5% by weight, the formation of the fluorine-containing coat is insufficient, resulting in a failure to sufficiently prevent production of an alteration product causing deterioration of silicon. If the ratio is more than 30% by weight, too much fluorine-containing coat increases the reaction resistance of the reaction between silicon and lithium, which also leads to deterioration of silicon.

The reason why determination of the F to Si ratio is preceded by at least 100 charge/discharge cycles is that, after experiencing about 100 charge/discharge cycles, the negative electrode active material layer becomes stationary enough to give reproducible results. While there is no upper limit to the number of charge/discharge cycles conducted before the determination, the upper limit is preferably about 120. The reason why the degree of charge and discharge is limited to 50% or more of the battery capacity is that common secondary batteries are charged and discharged to 50% of the battery capacity to be ready for use before shipment to the market. The phrase “50% of the battery capacity” as used herein means that a battery is charged and discharged to 50% of the maximum capacity of the battery. The maximum capacity of a battery is dependent on the maximum capacity of one of the positive and the negative electrodes that has a smaller capacity than the other. There is no upper limit to the degree of charge and discharge as long as it is at least 50%, and the degree of charge and discharge may be 100%. The degree of charge and discharge may be either the same or different from cycle to cycle but is preferably the same for obtaining results with good reproducibility. While the charge and discharge conditions are not particularly limited, a charge cut-off voltage of 4.2V, a discharge cut-off voltage of 2.7V, and a charge/discharge rate of 0.2 C are recommended for securing optimum reproducibility of results. These charge and discharge conditions may be the same or different from cycle to cycle but are preferably the same for obtaining results with good reproducibility, with the proviso that the first charge is performed under conditions described infra.

Besides having the fluorine to silicon weight ratio in the specified range, it is preferred for the active material layer of the negative electrode taken out after the above described charge/discharge cycles to have a ratio of regions containing 25% by weight or more of fluorine atom to regions containing 50% by weight or more of silicon atom (hereinafter sometimes referred to as “F to Si regional ratio”) of 0.05 to 0.5, more preferably 0.05 to 0.2, in element mapping. The F to Si regional ratio is a measure of the amount of a silicon alteration product that hinders silicon from absorbing and releasing silicon. With this regional ratio being 0.5 or smaller, the increase in reaction resistance caused by the silicon alteration product is reduced to improve cycle characteristics of the battery. While it is theoretically preferred for the F to Si regional ratio to be as small as possible, a ratio of about 0.05 would be enough to prevent an increase in reaction resistance due to the silicon alteration product. When the ratio is excessively small, there are cases in which a sufficient fluorine-containing coat is not formed. For this consideration, too, the lower limit is preferably 0.05.

A fluorine source used to form a fluorine-containing coat on the surface of silicon to prevent alteration of silicon is preferably a fluorine-containing nonaqueous solvent. While cyclic or acyclic nonaqueous solvents are commonly used in nonaqueous secondary batteries, a fluorine-containing cyclic nonaqueous solvent has proved suited for use in the invention. A fluorine-containing cyclic nonaqueous solvent has a higher reduction potential than a fluorine-free, cyclic nonaqueous solvent so that it easily decomposes during charge to form a reaction product with silicon. From this point of view, it is more preferred to use a fluorinated cyclic carbonate, particularly fluorinated ethylene carbonate as a fluorine-containing nonaqueous solvent. The fluorinated ethylene carbonate is preferably monofluorinated ethylene carbonate.

In order to successfully form a fluorine-containing coat on the surface of silicon, it is advantageous that the first charge of a nonaqueous secondary battery fabricated using the negative electrode together with a positive electrode, a separator, and a nonaqueous electrolyte containing a fluorine-containing solvent be performed at a low charge rate. The first charge at a low rate facilitates uniform progress of decomposition of the fluorine-containing nonaqueous solvent and reaction with silicon throughout the active material layer. Once a fluorine-containing coat is formed on the surface of silicon by the first charge, the following discharge and charge operations may be carried out at a rate higher than that of the first charge because the formation of the fluorine-containing coat is irreversible. Once the coat is formed, it does not disappear irrespective of the subsequent charge/discharge conditions.

To conduct the first charge at a low rate is also advantageous in terms of prevention of silicon's pulverization. By the first charge at a low rate, lithium is uniformly absorbed throughout the active material layer, whereby the charge/discharge load is evenly distributed throughout the active material layer. If the first charge is carried out at a high rate, the part of the active material close to the surface of the negative electrode preferentially absorbs lithium, resulting in local charge. That is, the charge/discharge load is apt to be locally imposed, and the active material in that location expands and contracts to such a considerable degree as to result in pulverization.

For all these considerations, a preferred charge rate in the first charge is 0.005 C to 0.03 C. The charge cut-off voltage in the first charge is not limited and may be, for example, 4.2 V as with the case of conventional batteries.

The nonaqueous electrolyte used in the secondary battery of the invention contains a fluorine-containing nonaqueous solvent as stated. The nonaqueous solvent may consist solely of a fluorine-containing nonaqueous solvent or may be a combination of a fluorine-containing nonaqueous solvent and a fluorine-free nonaqueous solvent. In using a fluorinated cyclic carbonate as a fluorine-containing nonaqueous solvent, since it has a relatively high viscosity, it is preferred to combine it with an acyclic nonaqueous solvent, which has a relatively low viscosity, for example, an acyclic carbonate in terms of improved electroconductivity of the nonaqueous electrolyte. Examples of such acyclic nonaqueous solvents include dimethyl carbonate, diethyl carbonate, and ethyl methyl carbonate. When a fluorinated cyclic carbonate and a fluorine-free acyclic nonaqueous solvent are used in combination, the former is preferably used in a proportion of 15% to 40% by volume, more preferably 20% to 40% by volume, even more preferably 25 to 40% by volume; and the latter is preferably used in a proportion of 60% to 85% by volume, more preferably 60% to 80% by volume, even more preferably 60% by 75% by volume. A nonaqueous electrolyte additionally containing 0.5% to 5% by weight of vinylene carbonate, 0.1% to 1% by weight of divinylsulfone, and 0.1% to 1.5% by weight of 1,4-butanediol dimethylsulfonate based on the total weight of the nonaqueous electrolyte is preferred to bring about further improved cycle characteristics.

Examples of the lithium salt as a supporting electrolyte include CF₃SO₃Li, (CF₃SO₂)NLi, (C₂F₅SO₂)₂NLi, LiClO₄, LiAlCl₄, LiPF₆, LiAsF₆, LiSbF₆, LiCl, LiBr, LiI, and LiC₄F₉SO₃. These lithium salts may be used individually or as a combination of two or more thereof. Among them preferred are CF₃SO₃Li, (CF₃SO₂)NLi, and (C₂F₅SO₂)₂NLi for their superior resistance to decomposition by water.

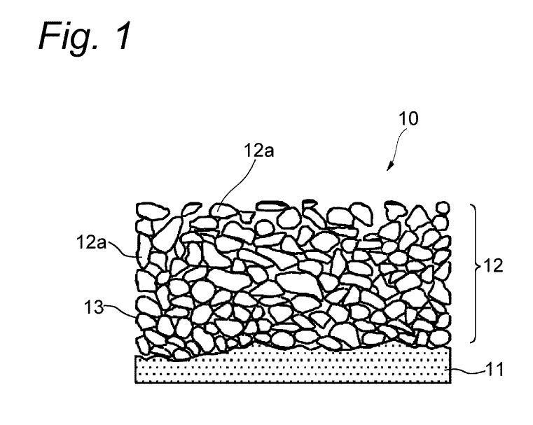

FIG. 1 schematically illustrates an example of the negative electrode that is preferably used in the secondary battery of the invention. The illustration represents the state of the negative electrode before being assembled into a battery. The negative electrode 10 of FIG. 1 includes a current collector 11 and an active material layer 12 formed on at least one side of the current collector 11. Although FIG. 1 shows only one active material layer 12 for the sake of convenience, the active material layer may be provided on both sides of the current collector 11.

The active material layer 12 contains silicon particles 12a as an active material and a deposited metallic material 13 between the particles 12a. The metallic material 13 is of a material different from the material of the particles 12a and having low capability of forming a lithium compound. The metallic material 13 covers at least part of the surface of the particles 12a. There are voids left vacant between the particles 12a coated with the metallic material 13. The metallic material 13 is deposited between the particles 12a while leaving voids through which a nonaqueous electrolyte containing lithium ions may reach the particles 12a. In FIG. 1, the metallic material 13 is depicted as a thick solid line defining the perimeter of the individual particles 12a for the sake of clarifying of the drawing. FIG. 1 is a two-dimensionally schematic illustration of the active material layer 12. In fact, the individual particles are in contact with one another either directly or via the metallic material 13. As used herein, the expression “low capability of forming a lithium compound” means no capability of forming an intermetallic compound or a solid solution with lithium or, if any, the capability is so limited that the resulting lithium compound contains only a trace amount of lithium or is very labile.

When the active material particles 12a have too large a specific surface area, a silicon alteration product is liable to generate. From this viewpoint, it is preferred that the particle size of the particles 12a not be too small. When, on the other hand, the particles 12a have too large a particle size, voids of appropriate size are hardly formed between the particles 12a. For these considerations, the average particle size in terms of D₅₀ of the particles 12 is preferably 0.3 to 4 μm, more preferably 1.5 to 3 μm. Because in the present invention the active material is prevented from pulverizing even after repetition of charge/discharge cycles, the recited range of average particle size D₅₀ of the active material particles 12a in the negative electrode 10 is maintained even after the charge/discharge cycles under the above specified conditions.

It is preferred that the metallic material 13 on the surface of the active material particles 12a be present throughout the thickness of the active material layer 12 in a mariner that the particles 12a exist in the matrix of the metallic material 13. By such a configuration, electron conductivity across the active material layer 12 is secured by the metallic material 13. In other words, the metallic material 13 forms an electroconductive network in the active material layer 12. Whether the metallic material 13 is present on the surface of the active material particles 12a throughout the thickness of the active material layer 12 can be confirmed by mapping the material 13 using an electron microscope.

The metallic material 13 covers the surface of the individual particles 12a continuously or discontinuously. Where the metallic material 13 covers the surface of the individual particles 12 continuously, it is preferred that the coat of the metallic material 13 have micropores for the passage of a nonaqueous electrolyte. Where the metallic material 13 covers the surface of the individual particles 12a discontinuously, a nonaqueous electrolyte is supplied to the particles 12a through the non-coated part of the surface of the particles 12a. As described, since the particles 12a do not pulverize with charge/discharge cycles, the metallic material 13 continues covering the surface of the particles 12a, that is, the electroconductive network between the particles 12a is retained even after the charge/discharge cycles under the above specified conditions.

The average thickness of the metallic material 13 covering the surface of the active material particles 12a is preferably as thin as 0.05 to 2 μm, more preferably 0.1 to 0.25 μm. The metallic material 13 thus covers the active material particles 12a with this minimum thickness, thereby to secure electron conductivity between the particles 12a while improving the energy density. As used herein the term “average thickness” denotes an average calculated from the thicknesses of the metallic material coat actually covering the surface of the particle 12a. The non-coated part of the surface of the particle 12a is excluded from the basis of calculation.

The voids formed between the particles 12a coated with the metallic material 13 serve as a flow passage for a nonaqueous electrolyte containing lithium ions. The voids allow the nonaqueous electrolyte to circulate smoothly in the thickness direction of the active material layer 12, thereby achieving improved cycle characteristics. The voids formed between the particles 12a also afford vacant spaces to serve to relax the stress resulting from volumetric changes of the active material particles 12a accompanying charge and discharge cycles. The volume gain of the active material particles 12a resulting from charging is absorbed by the voids. As a result, noticeable deformation of the negative electrode 10 is avoided effectively.

When the amount of the active material based on the whole negative electrode is too small, it is difficult to sufficiently increase the energy density. When the amount is too large, the active material layer has reduced strength, and the active material is apt to fall off. A suitable thickness of the active material layer 12 for these considerations is preferably 10 to 40 μm, more preferably 15 to 30 μm, even more preferably 18 to 25 μm.

The metallic material 13 has electroconductivity and is exemplified by copper, nickel, iron, cobalt, and their alloys. A highly ductile metallic material is preferred, which forms a coat break-proof against expansion and contraction of the active material particle 12a. A preferred example of such a material is copper.

The active material layer 12 is preferably formed by applying a slurry containing the particles 12a and a binder to a current collector, such as copper foil or stainless steel foil, drying the applied slurry to form a coating layer, and electroplating the coating layer in a plating bath having a prescribed composition to deposit a metallic material 13 between the particles 12a. For the details of the formation of the active material layer 12, reference can be made to JP 2007-27102A cited supra.

In using copper as the metallic material 13, it is preferred to use the plating bath having its pH adjusted to higher than 7, more preferably 7.1 to 11. Within the recited pH range, the surface of the particles 12a is cleaned, without being excessively dissolved, which accelerates deposition onto the particle surface, while leaving moderate voids between individual particles. The pH values recited here are those measured at the plating temperature. A plating bath containing copper pyrophosphate (hereinafter simply referred to as a copper pyrophosphate bath) is preferably used as a copper plating bath having a pH exceeding 7. To use a copper pyrophosphate bath is advantageous in that voids can easily be formed throughout the thickness of the active material layer 12 even when the active material layer has an increased thickness. Using a copper pyrophosphate bath offers an additional advantage that the metallic material 13, while being deposited on the surface of the active material particles 12a, is hardly deposited between the particles 12a so as to successfully leave vacant spaces therebetween. In using a copper pyrophosphate bath, a preferred composition and pH of the bath and preferred electrolysis conditions are as follows.

Copper pyrophosphate trihydrate: 85-120 g/l
Potassium pyrophosphate: 300-600 g/l
Potassium nitrate: 15-65 g/l
Bath temperature: 45°-60° C.
Current density: 1-7 A/dm²
pH: adjusted to 7.1 to 9.5, by the addition of aqueous ammonia and polyphosphoric acid.

When in using a copper pyrophosphate bath, the bath preferably has a weight ratio of P₂O₇ to Cu, P₂O₇/Cu (hereinafter referred to as a P ratio), of 5 to 12. With a bath having a P ratio less than 5, the plating layer coating the active material particles 12a tends to be thick, which can make it difficult to secure the voids between the active material particles 12a. With a bath having a P ratio more than 12, the current efficiency is reduced, and gas generation tends to accompany, which can result in reduced stability of production. A still preferred P ratio of the copper pyrophosphate plating bath is 6.5 to 10.5. When a plating bath with the still preferred P ratio is used, the size and the number of the voids formed between the active material particles 12a are very well suited for the passage of a nonaqueous electrolyte in the active material layer 12.

In the case of using the copper pyrophosphate bath, which has a pH on the alkaline side, the resulting negative electrode 10 having copper deposited on at least part of the surface of the active material particles 12a may contain an alkaline residue. The alkaline residue corrodes silicon to generate tetravalent silicon. Tetravalent silicon readily reacts with fluorine or lithium present in the battery, resulting in the formation of a silicon alteration product as previously mentioned. To avoid this, the negative electrode obtained by electroplating using a copper pyrophosphate bath is preferably subjected to acid washing to neutralize the alkaline residue. A diluted acid aqueous solution, such as a 0.001N to 1N aqueous solution of polyphosphoric acid, may be used as an acid washing solution.

After acid washing to neutralize the alkaline residue, the negative electrode 10 is preferably subjected to anti-corrosion treatment. Anti-corrosion treatment can be carried out using organic compounds, such as triazole compounds (e.g., benzotriazole, carboxybenzotriazole, and tolyltriazole) and imidazole, or inorganic substances, such as cobalt, nickel, and chromates.

### EXAMPLES

The present invention will now be illustrated in greater detail with reference to Examples, but it should be understood that the invention is not construed as being limited thereto.

### Example 1

A 18 μM thick electrolytic copper foil as a current collector was washed with an acid at room temperature for 30 seconds and washed with pure water for 15 seconds. A slurry of Si particles was applied to the current collector to a thickness of 15 μm to form a coating layer. The slurry contained the particles, styrene-butadiene rubber (binder), and acetylene black at a weight ratio of 100:1.7:2. The Si particles had an average particle size D₅₀ of 2.5 μm as measured using a laser diffraction scattering particle size analyzer Microtrack (Model 9320-X100) from Nikkiso Co., Ltd.

The current collector having the coating layer was immersed in a copper pyrophosphate bath having the following composition, and the coating layer was plated with copper by electrolysis under the following conditions to form an active material layer. A DSE was used as a positive electrode, and a direct current power source was used.

Copper pyrophosphate trihydrate: 105 g/l
Potassium pyrophosphate: 450 g/l
Potassium nitrate: 30 g/l
P ratio: 7.7
Bath temperature: 50° C.
Current density: 3 A/dm²
pH: adjusted to 8.2 by the addition of aqueous ammonia and polyphosphoric acid.

The electrolytic plating was stopped at the time when copper was deposited throughout the thickness of the coating layer. The current collector having the coating layer was washed with water, cleaned with a 0.01N polyphosphoric acid aqueous solution, followed by washing with water. Finally, the resulting negative electrode was treated with benzotriazole for anti-corrosion.

The negative electrode thus prepared was assembled into a coin type lithium secondary battery together with a positive electrode prepared as described below, a 20 μm thick polypropylene porous film as a separator, and a 1 mol/l LiPF₆ solution in a 25:75 by volume mixed solvent of monofluorinated ethylene carbonate (F-EC) and diethyl carbonate (DEC) as an electrolyte.

The positive electrode was made by applying a slurry of LiCO_{1/3}Ni_{1/3}Mn_{1/3}O₂ (active material), acetylene black, and polyvinylidene fluoride in N-methylpyrrolidone (solvent) to each side of a 20 μm thick aluminum foil.

The resulting secondary battery was charged (first charge) at a charge rate of 0.01 C to a cut-off voltage of 4.2 V.

### Comparative Example 1

A lithium secondary battery was made in the same manner as in Example 1 with the following exceptions. The negative electrode as obtained by electroplating was not washed with an acid solution. The electrolyte was a 1 mol/l solution of LiPF₆ in a 50:50 by volume mixed solvent of ethylene carbonate (EC) and diethyl carbonate (DEC) having 2% by volume vinylene carbonate externally added thereto. The charge rate of the first charge was 0.5 C.

### Comparative Example 2

A lithium secondary battery was made in the same manner as in Example 1, except that the negative electrode as obtained by electroplating was not washed with an acid solution and that the charge rate of the first charge was changed to 0.5 C.

### Evaluation

Each of the batteries obtained in Example and Comparative Examples was charged and discharged to 50% of the battery's capacity at 150 cycles under conditions: a charge cut-off voltage of 4.2 V, a discharge cut-off voltage of 2.7 V, and a charge/discharge rate of 0.2 C. The battery after 100 charge/discharge cycles in the course of 150 cycles was disassembled to take out the negative electrode, which was thoroughly washed with dimethyl carbonate and sliced to obtain a vertical cross-section. The cross-section was analyzed using an EDX analyzer (Pegasus System from EDAX) to determine a fluorine to silicon weight ratio of the active material layer. A 15 μm by 20 μm rectangular field of view was scanned at three points (n=3). Furthermore, the element mapping of the active material layer was performed using the EDX analyzer to determine a ratio of regions containing 25% by weight or more of fluorine atom to regions containing 50% by weight or more of silicon atom (F to Si regional ratio). A 15 μm by 20 μm rectangular field of view was scanned at three points (n=3). The results obtained are shown in Table 1 below. The conditions for the EDX analysis were as follows.

Accelerating voltage: 5 kV
Elements to be analyzed: C, O, F, Cu, Si, and P (the total amounting to 100 wt %)

### Resolution: 512×400

### Frame: 64

Drift correction system: on

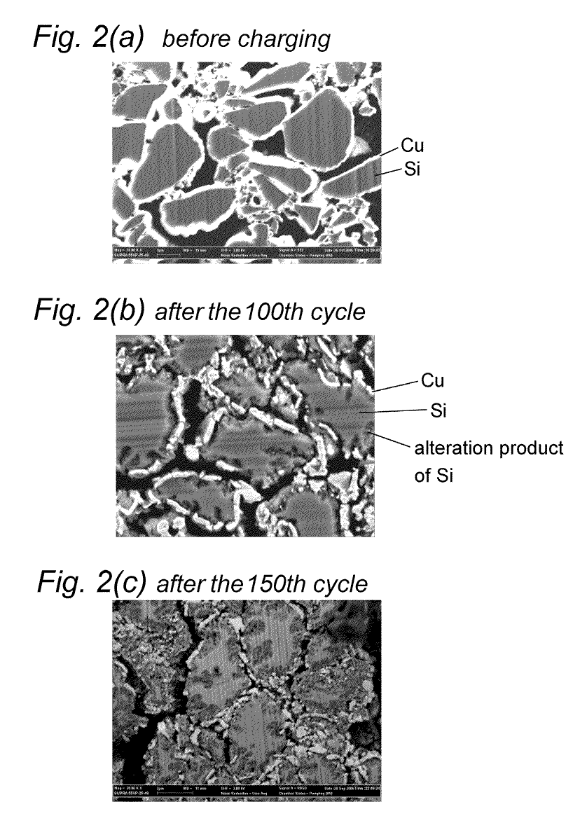

A backscatter electron image was acquired of a cross-section of the active material layer of (a) the negative electrode before the first charge, (b) the negative electrode taken out of the battery after 100 charge/discharge cycles, and (c) the negative electrode taken out of the battery after 150 charge/discharge cycles to observe production of an alteration product in the silicon particles, the condition of the copper coat on the surface of the silicon particles, and pulverization of the silicon particles. The results are shown in FIGS. 2(a) to 2(c).

Separately, the batteries of Example and Comparative Examples were evaluated for capacity retention in the 100th charge/discharge cycle. The capacity retention was obtained by dividing the discharge capacity in the 100th cycle by the initial discharge capacity and multiplying the quotient by 100. In this test, the batteries were charged at a constant current/constant voltage at 0.5 C and 4.2 V and discharged at a constant current at 0.5 C to 2.7 V. The discharge rate in the 1st cycle was 0.05 C, and the charge and discharge rates were 0.1 C in the 2nd to 4th cycles, 0.5 C in the 5th to 7th cycles, and 1 C in the 8th to 10th cycles. The results obtained are shown in Table 1.

TABLE 1

| | | | | | | Capacity |
|---|---|---|---|---|---|---|
| | | | 1st | | F to Si | Retention in |
| | Acid- | Nonaqueous | Charge | F/Si | Regional | 100th Cycle |
| | washed | Solvent (vol %) | Rate | (wt %) | Ratio | (%) |
| Example 1 | yes | F-EC/DEC = 25/75 | 0.01 C | 10 | 0.23 | 92 |
| Comparative | no | EC/DEC = 50/50 | 0.5 C | 3 | 0.02 | 83 |
| Example 1 | | | | | | |
| Comparative | no | F-EC/DEC = 25/75 | 0.5 C | 34 | 0.57 | 90 |
| Example 2 | | | | | | |

As is apparent from the results in Table 1, the battery of Example 1 has a higher capacity retention after the 100th cycle than the battery of Comparative Example 1, proving superior in cycle characteristics.

FIG. 2(a) shows that the silicon particles are covered with copper in the negative electrode before the first charge. FIG. 2(b) of the negative electrode after 100 cycles reveals formation of black spots near the surface of the silicon particles, which are considered to be an alteration product of silicon adversely affecting charge/discharge characteristics, but the amount of which is small. The silicon particles in FIG. 2(b) have not yet pulverized. Although the copper coat on the silicon particles is slightly segmentalized, the covering state is still maintained. After 150 cycles, as shown in FIG. 2(c), formation of black spots has proceeded from the state of FIG. 2(b), but the unaltered portion is still more than the altered portion of the silicon particles, and the silicon particles have not pulverized. The copper coat on the silicon particles are segmentalized more than that in FIG. 2(b) but still maintains the covering state.

### INDUSTRIAL APPLICABILITY

According to the invention, the silicon active material is prevented from alteration and pulverization when subjected to repeated charge/discharge cycles. The secondary battery of the invention is therefore superior in cycle characteristics. The method of the invention provides a battery with superior cycle characteristics.

1. A nonaqueous secondary battery comprising a negative electrode which has
an active material layer containing silicon as an active material and
a nonaqueous solvent containing a fluorine-containing solvent,
the active material layer of the negative electrode which is taken out of the battery after at least 100 charge/discharge cycles to 50% or more of the battery's capacity having a fluorine content of 5% to 30% by weight based on a silicon content in the active material layer.

2. The nonaqueous secondary battery according to claim 1, wherein the active material layer of the negative electrode which is taken out of the battery after at least 100 charge/discharge cycles to 50% or more of the battery's capacity has a ratio of regions containing 25% by weight or more of fluorine atom to regions containing 50% by weight or more of silicon atom of 0.05 to 0.5 in element mapping technique.

3. The nonaqueous secondary battery according to claim 1, wherein the fluorine-containing solvent is a fluorinated cyclic carbonate.

4. The nonaqueous secondary battery according to claim 1, wherein the active material comprises silicon particles, and the silicon particles of the active material layer of the negative electrode which is taken out of the battery after at least 100 charge/discharge cycles to 50% or more of the battery's capacity have an average particle size D₅₀ of 0.3 to 4 μm.

5. The nonaqueous secondary battery according to claim 4, wherein the silicon particles have a surface thereof covered at least partly with a coat of a metallic material having low capability of a lithium compound while leaving voids between the metallic material-covered particles.

6. The nonaqueous secondary battery according to claim 5, wherein the coat of the metallic material is formed by electroplating using a plating bath having a pH higher than 7, and the negative electrode is obtained by acid washing after the electroplating.

7. The nonaqueous secondary battery according to claim 1, which has been subjected to the first charge at a low rate of 0.005 C to 0.03 C.

8. A method of producing a nonaqueous secondary battery comprising the steps of:
making a negative electrode, the step of making a negative electrode comprising the substeps of applying a slurry containing particles of silicon as an active material to a current collector to form a coating layer, electroplating the coating layer using a copper plating bath at a pH higher than 7 to coat at least part of a surface of the particles with copper, and acid washing the plated coating layer,
assembling the negative electrode together with a positive electrode, a separator, and a nonaqueous electrolyte containing a fluorine-containing solvent into a nonaqueous secondary battery, and
subjecting the battery to a first charge operation at a low rate of 0.005 to 0.03 C.
